(19) United States
(12) Patent Application Publication
(10) Pub. No.: US 2013/0246729 A1
(43) Pub. Date: Sep. 19, 2013

(54) Method for Managing a Memory of a Computer System, Memory Management Unit and Computer System

(71) Applicant: HUAWEI TECHNOLOGIES CO., LTD., Shenzhen (CN)

(72) Inventors: Jiang Liu, Beijing (CN); Wei Wang, Hangzhou (CN); Xishi Qiu, Hangzhou (CN)

(73) Assignee: Huawei Technologies Co., Ltd., Shenzhen (CN)

(21) Appl. No.: 13/891,289

(22) Filed: May 10, 2013

Related U.S. Application Data
(63) Continuation of application No. PCT/CN2011/079202, filed on Aug. 31, 2011.

(51) Int. Cl. G06F 12/14

(52) U.S. Cl. CPC G06F 12/14
USPC 711/163

(57) ABSTRACT

A method for managing a memory of a computer system, a memory management unit and a computer system are provided. The method includes: receiving an allocation request sent by a user process; allocating the memory for the user process according to the allocation request and setting an offline flag for the memory; receiving a locking request sent by the user process; locking the memory according to the locking request and the offline flag of the memory; and taking the memory offline according to the offline flag of the memory. The computer system includes at least one memory and a memory management unit according to an embodiment of the present invention. Thus, through the interaction between a kernel and the user process and setting an offline mode for the memory, the memory locked by the user process is taken offline.

### CROSS-REFERENCE TO RELATED APPLICATIONS

This application is a continuation of International Application No. PCT/CN2011/079202, filed on Aug. 31, 2011, which is hereby incorporated by reference in its entirety.

### FIELD

The present invention relates to the field of computers, and in particular to a method for managing a memory of a computer system, a memory management unit, and a computer system in the computer field.

### BACKGROUND

A medium or high-end server is required to have a certain flexibility, and a hot-swap feature of a device is an important part of the flexibility. That is, the server may implement the dynamic addition or deletion of the device without interrupting a computer system, so as to achieve the objectives of capacity expansion and fault isolation, thereby meeting the requirements of reliability, service capability or energy saving of the computer system.

Hot-swap devices generally include, for example, a processor, a memory or an input output (IO) peripheral device, where the memory is one of the most important forming parts of the hot-swap devices as the memory is one of the important resources of the computer system. Memory hot-plugging refers to a memory device that is added without interrupting the computer system, and memory hot-drawing refers to a memory device that is deleted without interrupting the computer system. The memory hot-drawing needs to migrate and recover an occupied memory in a target memory. However, a non-migratable page exists in the computer system, including a physical page occupied by a kernel and a physical page locked by a user process.

In an application process, because the physical page occupied by the kernel is marked as a non-migratable page by the computer system, in a process of applying for a memory by the kernel, the computer system may allocate a physical memory from a specific area (a non-migratable memory area), so as to achieve an objective of taking the target memory offline. When the user process applies for a memory, the memory belongs to a common migratable memory, but after the user process designates to lock the memory, the memory is marked as a non-migratable page, which becomes an obstacle in taking the target memory offline. Whether the memory locked by the user process can be taken offline is one of the key factors in implementing the hot swap of the memory.

For the problem that the memory locked by the user process is hard to be taken offline, attempts may be repeatedly made to migrate the memory, with an expectation that the memory is unlocked by the user process during the repeated attempts. However, the migration method through repeated attempts cannot ensure that the memory is taken offline because unlocking the memory locked by the user process is not affected by the attempts to migrate the memory at all, and no necessary relationship exists between the two. Therefore, in the process of attempting to take the memory offline, the memory locked by the user process may be persistently kept in a locked state.

Therefore, there is a need for an appropriate solution to manage the memory of the computer system, so as to take the memory locked by the user process offline, thereby implementing the hot swap of the memory.

### SUMMARY

Embodiments of the present invention provide a method for managing a memory of a computer system, a memory management unit and a computer system, so as to take a memory locked by a user process offline, thereby implementing the hot swap of the memory.

In one aspect, an embodiment of the present invention provides a method for managing a memory of a computer system, where the method includes: receiving an allocation request sent by a user process, where the allocation request is used for requesting allocation of the memory of the computer system for the user process; according to the allocation request, allocating the memory for the user process and setting an offline flag for the memory, where the offline flag is used for indicating an offline mode of the memory; receiving a locking request sent by the user process, where the locking request is used for requesting locking the memory; according to the locking request and the offline flag of the memory, locking the memory; and taking the memory offline according to the offline flag of the memory.

In another aspect, an embodiment of the present invention provides a memory management unit where the memory management unit includes: a first receiving module, configured to receive an allocation request sent by a user process, where the allocation request is used for requesting allocation of a memory of a computer system for the user process; an allocation module, configured to allocate the memory for the user process according to the allocation request received by the first receiving module, and set an offline flag for the memory, where the offline flag is used for indicating an offline mode of the memory; a second receiving module, configured to receive a locking request sent by the user process, where the locking request is used for requesting locking the memory of the computer system; a locking module, configured to lock the memory according to the locking request received by the second receiving module and the offline flag of the memory; and an offline module, configured to take the memory locked by the locking module offline according to the offline flag of the memory.

In still another aspect, an embodiment of the present invention provides a computer system, where the computer system includes at least one memory; and a memory management unit according to an embodiment of the present invention, and the memory management unit is configured to manage the at least one memory. The memory management unit includes: a first receiving module, configured to receive an allocation request sent by a user process, where the allocation request is used for requesting allocation of a memory of the computer system for the user process; an allocation module, configured to allocate the memory for the user process according to the allocation request received by the first receiving module and set an offline flag for the memory, where the offline flag is used for indicating an offline mode of the memory; a second receiving module, configured to receive a locking request sent by the user process, where the locking request is used for requesting locking the memory of the computer system; a locking module, configured to lock the memory according to the locking request received by the second receiving module and the offline flag of the memory; and an offline module, configured to take the memory locked by the locking module offline according to the offline flag of the memory.

Based on the above technical solutions, in the method for managing the memory of the computer system, the memory management unit and the computer system according to the embodiments of the present invention, through the interaction between a kernel and the user process, and setting an offline mode for the memory, the kernel can correspondingly take the memory offline according to the offline mode of the memory, so as to take the memory locked by the user process offline, thereby implementing the hot swap of the memory and avoiding the waste of system resources.

### BRIEF DESCRIPTION OF THE DRAWINGS

To illustrate the technical solutions according to the embodiments of the present invention more clearly, the accompanying drawings for describing the embodiments are introduced briefly in the following. The accompanying drawings in the following description are some embodiments of the present invention, and persons skilled in the art may derive other drawings from the accompanying drawings without creative efforts.

FIG. 1A is a schematic flow chart of a method for managing a memory of a computer system according to an embodiment of the present invention;

FIG. 1B is a schematic flow chart of a method for managing a memory of a computer system according to another embodiment of the present invention;

FIG. 1C is a schematic flow chart of a method for managing a memory of a computer system according to still another embodiment of the present invention;

FIG. 2 is a schematic flow chart of a method for modifying an offline mode of a memory according to an embodiment of the present invention;

FIG. 3 is a schematic flow chart of a method for locking a memory according to an embodiment of the present invention;

FIG. 4 is a schematic flow chart of a method for taking a locked memory offline according to an embodiment of the present invention;

FIG. 5 is a schematic flow chart of a method for unlocking a memory according to an embodiment of the present invention;

FIG. 6 is a schematic block diagram of a memory management unit according to an embodiment of the present invention;

FIG. 7 is a schematic block diagram of a memory management unit according to another embodiment of the present invention;

FIG. 8 is a schematic block diagram of a memory management unit according to still another embodiment of the present invention;

FIG. 9 is a schematic block diagram of a locking module according to an embodiment of the present invention;

FIG. 10 is a schematic block diagram of an offline module according to an embodiment of the present invention;

FIG. 11 is a schematic block diagram of a determination module according to an embodiment of the present invention; and

FIG. 12 is a schematic block diagram of a computer system according to an embodiment of the present invention.

### DETAILED DESCRIPTION OF THE EMBODIMENTS

The technical solutions according to the embodiments of the present invention are to be clearly described in the following with reference to the accompanying drawings in the embodiments of the present invention. It is obvious that the embodiments to be described are a part, rather than all, of the embodiments of the present invention. All other embodiments obtained by persons skilled in the art based on the embodiments of the present invention without creative efforts shall fall within the protection scope of the present invention.

It should be noted that, the technical solutions according to the embodiments of the present invention may be applicable to various computer systems, including a personal computer (PCs), a large-scale computer system or various supercomputers. In the embodiments of the present invention, a computer system including at least one memory is taken as an example for description, but the embodiments of the present invention are not limited thereto.

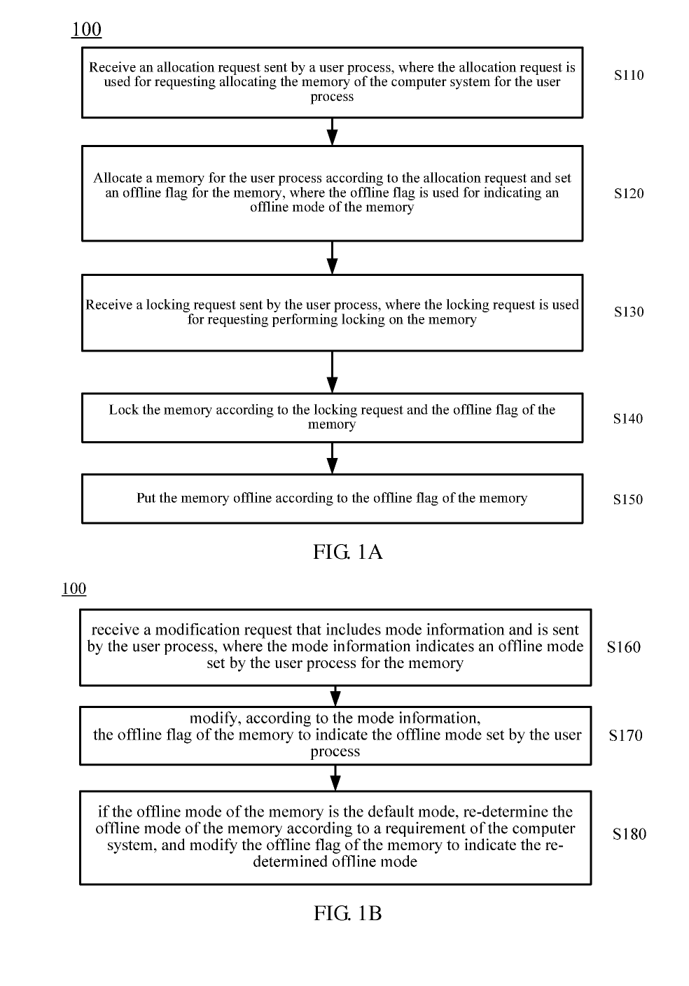

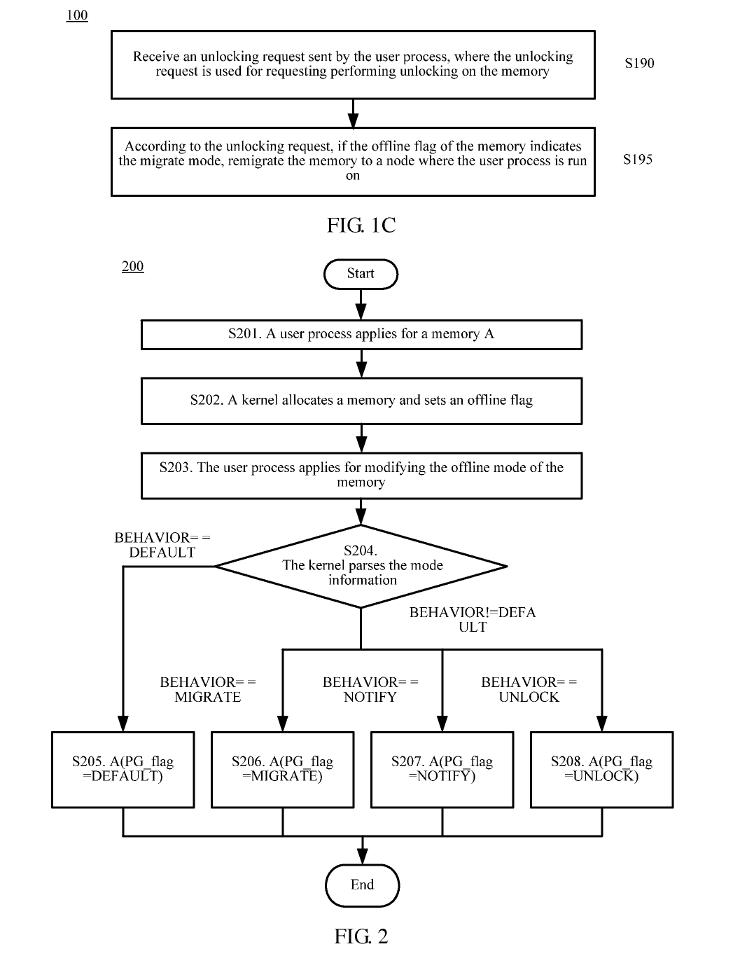

FIG. 1A is a schematic flow chart of a method 100 for managing a memory of a computer system according to an embodiment of the present invention. As shown in FIG. 1A, the method 100 includes:

S110: Receive an allocation request sent by a user process, where the allocation request is used for requesting allocation of the memory of the computer system for the user process.

S120: Allocate a memory for the user process according to the allocation request and set an offline flag for the memory, where the offline flag is used for indicating an offline mode of the memory.

S130: Receive a locking request sent by the user process, where the locking request is used for requesting that the memory be locked.

S140: Lock the memory according to the locking request and the offline flag of the memory.

S150: take the memory offline according to the offline flag of the memory.

After receiving an allocation request that is sent by a user process and used to request allocating a memory of the computer system, a kernel, an operating system or a memory management unit of a computer system allocates a memory for the user process, and sets an offline flag for the memory, for indicating an offline mode of the memory; and after receiving a request that is sent by the user process and used to request locking the memory, the kernel or the operating system may lock the memory according to the locking request of the user process and the offline flag of the memory, and may take the memory offline according to the offline flag of the memory when it is required to take the locked memory offline.

Therefore, in the method for managing the memory of the computer system according to the embodiment of the present invention, through the interaction between the kernel and the user process, and setting the offline mode for the memory, the kernel can correspondingly take the memory offline according to the offline mode of the memory, so as to take the memory locked by the user process offline, thereby implementing the hot swap of the memory and avoiding the waste of system resources.

In the embodiment of the present invention, the offline mode or an offline policy may include at least one of a default mode, a migrate mode, a notify mode and a forcible unlock mode. Optionally, the offline mode includes the default mode, the migrate mode, the notify mode and the forcible unlock mode.

For the default mode, the user process may designate that the memory is taken offline through the default mode, and when the user process does not designate the offline policy, such a mode may also be used. For the migrate mode, before the memory is locked, the memory needs to be migrated to a non-migratable area and is then locked. For, the notify mode, before the kernel is required to take the memory offline, the kernel triggers the user process to unlock the memory. For the forcible unlock mode, the kernel may forcibly unlock the memory when the kernel is required to take the memory offline, and then takes the memory offline. It should be noted that, names and brief description of the four offline modes in the embodiment of the present invention are merely provided for ease of understanding of the embodiment of the present invention, but the embodiment of the present invention is not limited thereto. Moreover, the specific meanings of the four offline modes should be understood with reference to the specific operations described in the embodiment of the present invention.

In the embodiment of the present invention, the user process may modify the offline mode of an applied memory according to a requirement, that is, the user process may set the offline mode of the memory. Therefore, as shown in FIG. 1B, the method 100 for managing a memory of a computer system according to the embodiment of the present invention may further include:

S160: Receive a modification request that includes mode information and is sent by the user process, where the mode information indicates an offline mode set by the user process for the memory.

S170: Modify, according to the mode information, the offline flag of the memory to indicate the offline mode set by the user process.

That is, after the user process applies for the memory, the user process may set an offline mode for the applied memory according to a requirement, and sends a modification request including the mode information to the kernel, so that the kernel modifies, according to the mode information, the offline flag of the memory to indicate the offline mode set by the user process.

In the embodiment of the present invention, after the kernel receives the locking request sent by the user process, the kernel may determine the offline mode of the memory according to the offline flag of the memory, and if the offline mode of the memory is the default mode, the kernel may reset the offline mode of the memory as desired. That is, as shown in FIG. 1B, the method 100 according to the embodiment of the present invention may further include:

S180: If the offline mode of the memory is the default mode, re-determine the offline mode of the memory according to the requirement of the computer system, and modify the offline flag of the memory to indicate the re-determined offline mode.

Optionally, if the computer system requires system operating performance, the kernel determines the offline mode of the memory to be the default mode; and if the computer system requires hot-swap performance, the kernel determines the offline mode of the memory to be the migrate mode.

It should be noted that, the method according to the embodiment of the present invention may be executed by the kernel, the operating system or the memory management unit. For ease of description, the kernel is used as an execution body in the following, but the embodiment of the present invention is not limited thereto.

Specifically, in step S110, the user process may send, according to a requirement of the user process, an allocation request to the kernel for requesting allocating a memory.

In step S120, the kernel allocates a memory for the user process according to the allocation request and sets an offline flag for the memory, where the offline flag is used for indicating an offline mode of the memory. Optionally, the kernel sets an offline flag indicating a default mode for the allocated memory. For example, the kernel may add an offline flag PG_flag for the memory, and assigns a value DEFAULT to the offline flag, that is, PG_flag=DEFAULT. Definitely, the kernel may also set other offline modes for the memory, and the embodiment of the present invention is not limited thereto.

Optionally, the user process may set or formulate the offline mode or an offline policy for the applied memory through an interface provided by the kernel. Specifically, in step S160, the user process may send, according to a requirement of the user process, a modification request to the kernel for modifying the offline mode of the memory, where the modification request includes mode information for indicating the offline mode set by the user process for the memory. For example, the modification request may include a BEHAVIOR parameter, where the BEHAVIOR parameter may be assigned a value such as DEFAULT, MIGRATE, NOTIFY, and UNLOCK, which respectively indicate that the user process sets the offline mode of the memory to be a default mode, a migrate mode, a notify mode, and a forcible unlock mode.

In step S170, the kernel modifies the offline mode of the memory according to the mode information. Specifically, the kernel may modify, according to the BEHAVIOR parameter delivered in the modification request, the offline flag of the memory to indicate the offline mode set by the user process.

Specifically, for example, for a memory A whose offline mode is requested to be modified, the kernel may parse the parameter BEHAVIOR included in the modification request. If BEHAVIOR==DEFAULT, the kernel may determine that the user process sets the offline mode of the memory A to be the default mode. At this time, the kernel may modify the offline flag PG_flag of the memory A, that is, assign a value DEFAULT to the offline flag, that is, PG_flag=DEFAULT. If BEHAVIOR==MIGRATE, the kernel may determine that the user process sets the offline mode of the memory A to be the migrate mode, and at this time, the kernel may assign a value MIGRATE to the offline flag of the memory A, that is, PG_flag=MIGRATE Likewise, if BEHAVIOR==NOTIFY, the kernel may determine that the user process sets the offline mode of the memory A to be the notify mode, and at this time, the kernel may assign a value NOTIFY to the offline flag of the memory A, that is, PG_flag=NOTIFY. If BEHAVIOR==UNLOCK, the kernel may determine that the user process sets the offline mode of the memory A to be the forcible unlock mode, and at this time, the kernel may assign a value UNLOCK to the offline flag of the memory A, that is, PG_flag=UNLOCK.

In step S130, the user process may request, according to a requirement of the user process, to the kernel for locking the memory of the computer system.

In step S140, after the kernel receives the locking request sent by the user process, the kernel needs to determine an offline mode of the memory requested to be locked, and locks the memory according to the specific offline mode and the locking request.

Specifically, the kernel may determine the offline mode of the memory by parsing the offline flag of the memory. For example, if the kernel determines that the offline flag of the memory is PG_flag=DEFAULT, the offline mode of the memory is the default mode. Likewise, if the kernel determines that the offline flag of the memory PG_flag is MIGRATE, NOTIFY or UNLOCK, the kernel may determine that the offline mode of the memory is the migrate mode, the notify mode or the forcible unlock mode.

Optionally, if the offline flag of the memory indicates the default mode, the notify mode, or the forcible unlock mode, the memory is locked. If the offline flag of the memory indicates the migrate mode, the memory is migrated, and if the memory is migrated successfully, the migrated memory is locked and an offline flag indicating the migrate mode is set for the migrated memory. If the memory is migrated unsuccessfully, the memory is locked and the offline flag of the memory is modified to indicate the default mode.

Optionally, if the kernel determines that the offline mode of the memory is the default mode, the kernel may re-determine a more appropriate offline mode for the memory. That is, in step S180, the kernel re-determines the offline mode of the memory according to the requirement of the computer system, and modifies the offline flag of the memory to indicate the re-determined offline mode.

In step S150, if the kernel needs to take the memory locked by the user process offline, the kernel may determine the offline mode of the memory by parsing the offline flag of the memory, and take the memory offline according to the offline mode.

Optionally, if the offline flag of the memory indicates the default mode or the migrate mode, the memory is waited to be unlocked, and is migrated after the memory is unlocked. If the offline flag of the memory indicates the notify mode, the user process is triggered to unlock the memory, the memory is migrated after the memory is unlocked, and the user process is triggered to lock the migrated memory after the memory is migrated. If the offline flag of the memory indicates the forcible unlock mode, the memory is unlocked and is migrated after the memory is unlocked, the migrated memory is locked, and an offline flag indicating the forcible unlock mode is set for the migrated memory.

Therefore, in the method for managing the memory of the computer system according to the embodiment of the present invention, through the interaction between the kernel and the user process, and setting the offline mode for the memory, the kernel can correspondingly take the memory offline according to the offline mode of the memory, so as to take the memory locked by the user process offline, thereby implementing the hot swap of the memory and avoiding the waste of system resources.

In an embodiment of the present invention, optionally, if the user process applies for unlocking the locked memory, as shown in FIG. 1C, the method 100 according to the embodiment of the present invention further includes:

S190: Receive an unlocking request sent by the user process, where the unlocking request is used for requesting that the memory be unlocked.

S195: According to the unlocking request, if the offline flag of the memory indicates the migrate mode, remigrate the memory to a node where the user process is run on.

That is, in a process that the user process actively requests unlocking the locked memory, if the offline flag of the memory indicates that the offline mode of the memory is the migrate mode, before the locked memory is unlocked, the kernel may apply for a local memory, so as to remigrate the locked memory to the node where the user process is run on. For a locked memory with the offline mode being the default mode, the notify mode or the forcible unlock mode, the kernel may directly unlock the locked memory according to the application of the user process. For example, in this case, for a locked memory with a MIGRATE offline flag, before being unlocked, the memory is remigrated to the node where the user process is run on, which can further improve the system performance.

It should be noted that, the sequence numbers of the above steps do not imply an execution sequence, and the execution sequence of the steps should be determined according to the functions and internal logic, which is not intended to limit the implementation process of the embodiment of the present invention in any way.

Therefore, in the method for managing the memory of the computer system according to the embodiment of the present invention, through the interaction between the kernel and the user process, and setting the offline mode for the memory, the kernel can correspondingly take the memory offline according to the offline mode of the memory, so as to take the memory locked by the user process offline, thereby implementing the hot swap of the memory, improving the system performance and avoiding waste of system resources.

With reference to the specific embodiments shown in FIG. 2 to FIG. 5, a method for modifying an offline mode of a memory, a method for locking a memory, a method for taking a locked memory offline, and a method for unlocking a memory according to the embodiments of the present invention are described in detail below.

As shown in FIG. 2, a method 200 for setting an offline mode of a memory according to an embodiment of the present invention includes:

S201: A user process applies for a memory A according to a requirement of the user process.

S202: A kernel allocates a memory for the user process according to an allocation request sent by the user process and sets an offline flag for the memory, where the offline flag is used for indicating an offline mode of the memory. Optionally, the kernel sets the offline flag PG_flag of the memory to be a default mode DEFAULT, that is, PG_flag=DEFAULT.

Optionally, after the user process applies for and obtains the memory A, the user process may set the offline mode of the memory A through an interface provided by the kernel, where the offline mode includes a default mode, a migrate mode, a notify mode and a forcible unlock mode.

S203: The user process sends a modification request to the kernel for applying for modifying the offline mode of the memory, where the modification request includes mode information for indicating the offline mode set by the user process for the memory, and the mode information is, for example, a BEHAVIOR parameter.

S204: The kernel determines the offline mode set by the user process for the memory A by parsing the mode information such as the BEHAVIOR parameter delivered by the user process.

If the offline mode set by the user process for the memory A is the default mode, the process proceeds to step S205; and if the offline mode set by the user process for the memory A is not the default mode, the process proceeds to step S206, step S207, or step S208. Specifically, if the offline mode set by the user process for the memory A is the migrate mode, the process proceeds to step S206; if the offline mode set by the user process for the memory A is the notify mode, the process proceeds to step S207; and if the offline mode set by the user process for the memory A is the forcible unlock mode, the process proceeds to step S208.

S205: The kernel assigns a value DEFAULT to the offline flag of the memory, that is, PG_flag=DEFAULT. At this time, for the memory A with the offline mode set by the user process being the default mode, the process of setting the offline mode of the memory A is over.

S206: The kernel assigns a value to the offline flag of the memory A, that is, PG_flag=MIGRATE. At this time, for the memory A with the offline mode set by the user process being the migrate mode, a process of setting an offline mode for the memory A is over.

S207: The kernel assigns a value NOTIFY to the offline flag of the memory A, that is, PG_flag=NOTIFY. At this time, for the memory A with the offline mode set by the user process being the notify mode, the process of setting the offline mode of the memory A is over.

S208: The kernel assigns a value UNLOCK to the offline flag of the memory A, that is, PG_flag=UNLOCK. At this time, for the memory A with the offline mode set by the user process being the forcible unlock mode, the process of setting the offline mode of the memory A is over.

It should be noted that, the sequence numbers of the above steps do not imply an execution sequence, and the execution sequence of the steps should be determined according to the functions and internal logic, which is not intended to limit the implementation process of the embodiment of the present invention in any way.

Therefore, through the interaction between the kernel and the user process, and setting the offline mode for the memory, the kernel can correspondingly lock the memory and take the memory offline according to the offline mode of the memory, so as to take the memory locked by the user process offline.

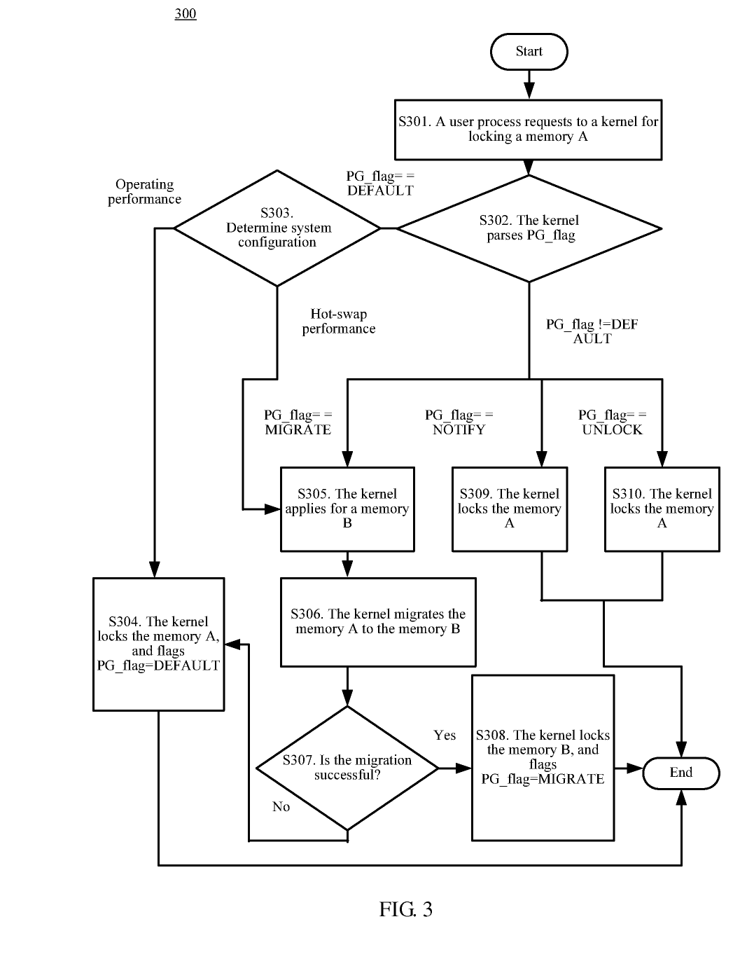

FIG. 3 is a schematic flow chart of a method 300 for locking a memory according to an embodiment of the present invention. As shown in FIG. 3, the method 300 includes:

S301: A user process may request, according to a requirement, to a kernel for locking a memory A.

S302: The kernel determines an offline mode set for the memory A by parsing an offline flag PG_flag of the memory A.

If the kernel determines that the offline mode of the memory A is a default mode, that is, PG_flag==DEFAULT, the process proceeds to step S303; and if the kernel determines that the offline mode of the memory A is not the default mode, that is, PG_flag !=DEFAULT, the process proceeds to step S305, step S309 or step S310. Specifically, if the kernel determines that the offline mode of the memory A is a migrate mode, that is, PG_flag==MIGRATE, the process proceeds to step S305; if the kernel determines that the offline mode of the memory A is a notify mode, that is, PG_flag==NOTIFY, the process proceeds to step S309; and if the kernel determines that the offline mode of the memory A is a forcible unlock mode, that is, PG_flag==UNLOCK, the process proceeds to step S310.

S303: The kernel determines configuration or requirements of a computer system. If the kernel determines that the computer system requires the system operating performance, the process proceeds to step S304; and if the computer system requires the hot-swap performance, the process proceeds to step S305.

S304: If the offline mode of the memory A is a default mode, the kernel locks the memory A, and assigns a value DEFAULT to the offline flag of the memory, that is, PG_flag=DEFAULT. At this time, for the memory A with the offline mode being the default mode, the process of locking the memory A is over.

S305: If the offline mode of the memory A is a migrate mode, the kernel re-applies for a memory B at a designated area of the system, where the designated area is a non-migratable memory area and is generally limited on a primary node.

S306: The kernel migrates the memory A to the memory B, and releases the memory A.

S307: The kernel determines whether the memory A is migrated successfully. If the memory A is migrated successfully, the process proceeds to step S308; otherwise, the process proceeds to step S304.

S308: The kernel locks the memory B, sets an offline flag PG_flag for the memory B, and assigns a value MIGRATE to the offline flag, that is, PG_flag=MIGRATE. At this time, for the memory A with the offline mode being the migrate mode, the process of locking the memory A is over.

S309: If the offline mode of the memory A is a notify mode, the kernel locks the memory A. At this time, for the memory A with the offline mode being the notify mode, the process of locking the memory A is over.

S310: If the offline mode of the memory A is the forcible unlock mode, the kernel locks the memory A. At this time, for the memory A with the offline mode being the forcible unlock mode, the process of locking the memory A is over.

It should be noted that the sequence numbers of the above steps do not imply an execution sequence, and the execution sequence of the steps should be determined according to the functions and internal logic, which is not intended to limit the implementation process of the embodiment of the present invention in any way.

FIG. 4 is a schematic flow chart of a method 400 for taking a locked memory offline according to an embodiment of the present invention. As shown in FIG. 4, the method 400 includes:

S401: A kernel determines to take a memory A offline according to a requirement.

S402: The kernel determines an offline mode set for the memory A by parsing an offline flag PG_flag of the memory A.

If the kernel determines that the offline mode of the memory A is a default mode, that is, PG_flag==DEFAULT, the process proceeds to step S403; and if the kernel determines that the offline mode of the memory A is not the default mode, that is, PG_flag !=DEFAULT, the process proceeds to step S403, step S406 or step S408. Specifically, if the kernel determines that the offline mode of the memory A is a migrate mode, that is, PG_flag==MIGRATE, the process proceeds to step S403; if the kernel determines that the offline mode of the memory A is a notify mode, that is, PG_flag==NOTIFY, the process proceeds to step S406; and if the kernel determines that the offline mode of the memory A is a forcible unlock mode, that is, PG_flag==UNLOCK, the process proceeds to step S408.

S403: If the offline mode of the memory A is a default mode or a migrate mode, the kernel waits for the memory A to be unlocked by the user process.

S404: The kernel checks whether the memory A is unlocked by the user process. If the memory A is unlocked, the process proceeds to step S405; otherwise, the process proceeds to step S403, that is, the kernel continues to wait for the memory A to be unlocked.

S405: if the memory A is unlocked by the user process, the kernel migrates the memory A. It should be noted that, the migrating the memory A is migrating the memory A to other memories. For a new memory after the migration, the kernel may set an offline flag of the new memory to be PG_flag=DEFAULT. At this time, for the memory A with the offline mode being the default mode or the migrate mode, the process of taking the memory A offline is over.

S406: If the offline mode of the memory A is a notify mode, the kernel triggers the user process to unlock the memory, and migrates the memory A after the memory A is unlocked by the user process. That is, in the case that the offline mode of the memory A is the notify mode, the process proceeds from step S406, to step S404, step S405 and step S407.

S407: After the memory A is migrated, the kernel triggers the user process to lock a new memory after the migration. For the new memory after the migration, the kernel may set an offline flag of the new memory to be PG_flag=NOTIFY. At this time, for the memory A with the offline mode being the notify mode, the process of taking the memory A offline is over.

S408: If the offline mode of the memory A is a forcible unlock mode, the kernel unlocks the memory A.

S409: The kernel checks whether the memory A is successfully unlocked. If the memory A is unlocked, the process proceeds to step S410; otherwise, the process proceeds to step S408, that is, the kernel continues to unlock the memory A.

S410: After the memory A is unlocked, the kernel migrates the memory A, for example, the kernel migrates the memory A to a memory B.

S411: The kernel locks the new memory B, and sets an offline flag for the new memory B, so as to identify that an offline mode of the new memory B is a forcible unlock mode, that is, a value assigned to the offline flag is UNLOCK, that is, PG_flag=UNLOCK. At this time, for the memory A with the offline mode being the forcible unlock mode, the process of taking the memory A offline is over.

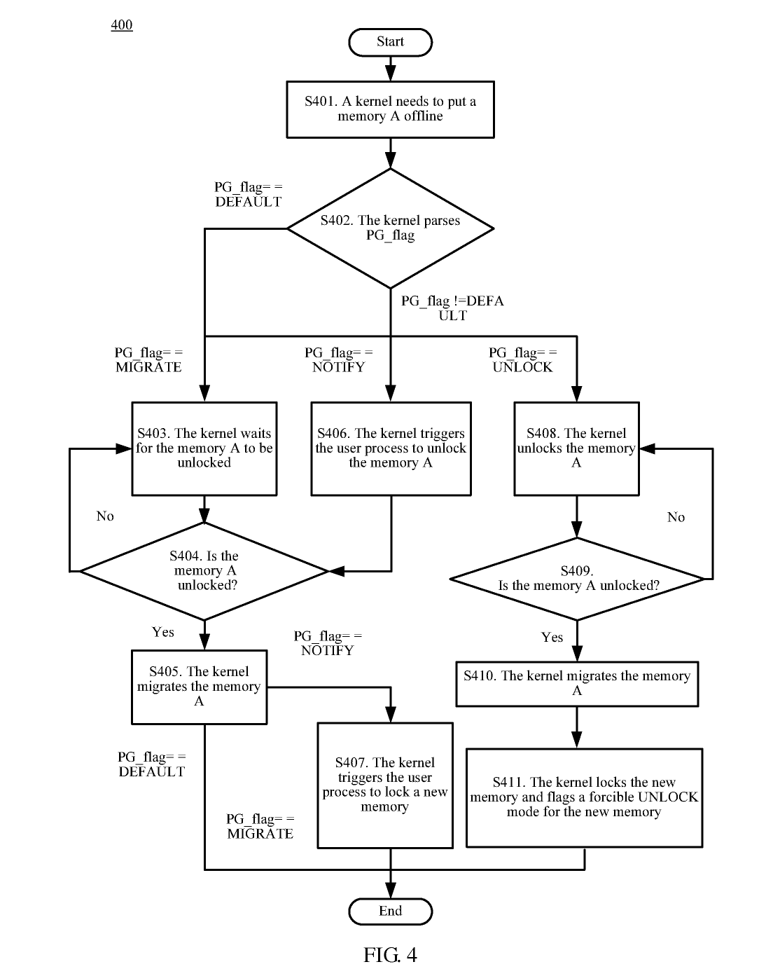

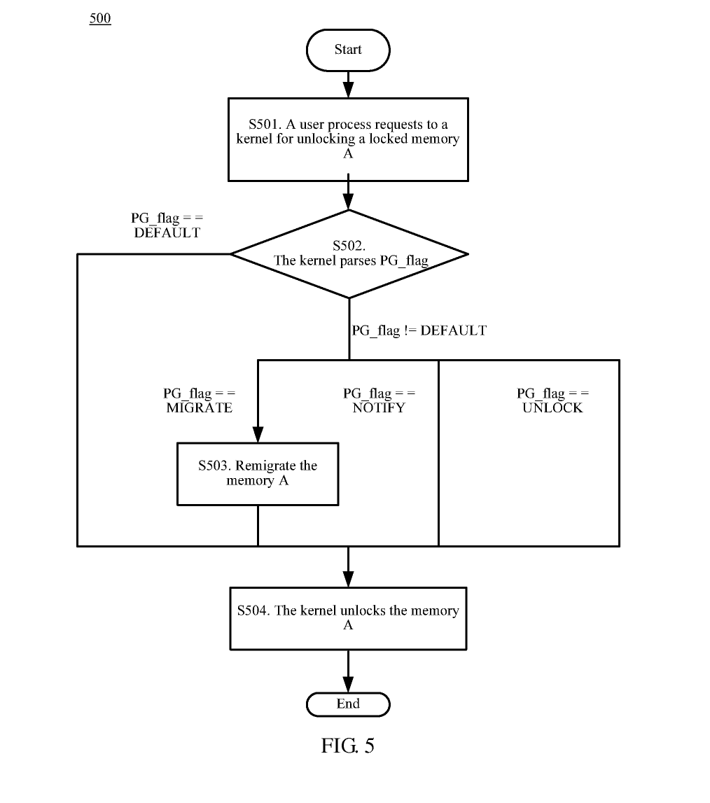

FIG. 5 is a schematic flow chart of a method 500 for unlocking a memory according to an embodiment of the present invention. As shown in FIG. 5, the method 500 includes:

S501: A user process requests to a kernel for unlocking a locked memory A.

S502: The kernel determines an offline mode of the memory A by parsing an offline flag of the memory A.

If the kernel determines that the offline mode of the memory A is a default mode, that is, PG_flag==DEFAULT, the process proceeds to step S504; and if the kernel determines that the offline mode of the memory A is not the default mode, that is, PG_flag !=DEFAULT, the process proceeds to step S503 or step S504. Specifically, if the kernel determines that the offline mode of the memory A is a migrate mode, that is, PG_flag==MIGRATE, the process proceeds to step S503 and step S504; and if the kernel determines that the offline mode of the memory A is a notify mode, that is, PG_flag==NOTIFY; or a forcible unlock mode, that is, PG_flag==UNLOCK, the process is directly proceeded to step S504.

S503: The kernel remigrates the memory A to a node where the user process is run on, so as to further improve system performance.

S504: The kernel unlocks the memory A. At this time, the process of unlocking the locked memory A by the user process is over.

It should be noted that, the sequence numbers of the above steps do not imply an execution sequence, and the execution sequence of the steps should be determined according to the functions and internal logic, which is not intended to limit the implementation process of the embodiments of the present invention in any way.

Therefore, in the method for managing the memory of the computer system according to the embodiment of the present invention, through interaction between the kernel and the user process, and setting the offline mode for the memory, the kernel can correspondingly take the memory offline according to the offline mode of the memory, so as to take the memory locked by the user process offline, thereby implementing the hot swap of the memory, improving the system performance and avoiding the waste of system resources.

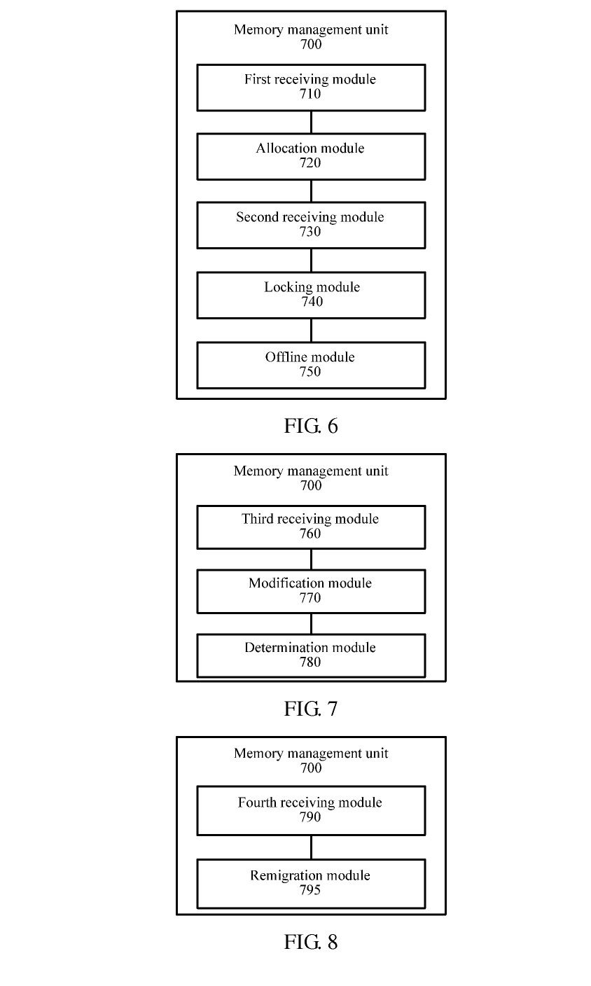

In the above with reference to FIG. 1A to FIG. 5, the method for managing the memory of the computer system according to the embodiments of the present invention is described in detail, and a memory management unit and a computer system according to the embodiments of the present invention are described in detail with reference to FIG. 6 to FIG. 12 in the following.

FIG. 6 is a schematic block diagram of a memory management unit 700 according to an embodiment of the present invention. As shown in FIG. 6, the memory management unit 700 includes: a first receiving module 710, configured to receive an allocation request sent by a user process, where the allocation request is used for requesting allocation of a memory of a computer system for the user process; an allocation module 720, configured to allocate the memory for the user process according to the allocation request received by the first receiving module 710, and set an offline flag for the memory, where the offline flag is used for indicating an offline mode of the memory; a second receiving module 730, configured to receive a locking request sent by the user process, where the locking request is used for requesting locking the memory of the computer system; a locking module 740, configured to lock the memory according to the locking request received by the second receiving module 730 and the offline flag of the memory; and an offline module 750, configured to take the memory locked by the locking module offline according to the offline flag of the memory.

In the memory management unit according to the embodiment of the present invention, through the interaction between a kernel and the user process, and setting the offline mode for the memory, the kernel can correspondingly take the memory offline according to the offline mode of the memory, so as to take the memory locked by the user process offline, thereby implementing the hot swap of the memory, improving the system performance and avoiding the waste of system resources.

In the embodiment of the present invention, optionally, the offline mode or an offline policy may include at least one of a DEFAULT mode, a MIGRATE mode, a NOTIFY mode and a forcible UNLOCK mode. Optionally, the offline mode includes the default mode, the migrate mode, the notify mode and the forcible unlock mode.

In an embodiment of the present invention, optionally, as shown in FIG. 7, the memory management unit 700 further includes: a third receiving module 760, configured to receive a modification request that includes mode information and is sent by the user process, where the mode information indicates an offline mode set by the user process for the memory; and a modification module 770, configured to modify, according to the mode information received by the third receiving module 760, the offline flag of the memory to indicate the offline mode set by the user process.

In the embodiment of the present invention, optionally, as shown in FIG. 7, the memory management unit 700 further includes: a determination module 780, configured to, if the offline mode of the memory is the default mode, re-determine the offline mode of the memory according to a requirement of the computer system, and modify the offline flag of the memory to indicate the re-determined offline mode.

Optionally, as shown in FIG. 8, the memory management unit 700 further includes: a fourth receiving module 790, configured to receive an unlocking request sent by the user process, where the unlocking request is used for requesting that the memory be unlocked; and a remigration module 795, configured to, according to the unlocking request received by the fourth receiving module and when the offline flag of the memory indicates the migrate mode, remigrate the memory to a node where the user process is run on.

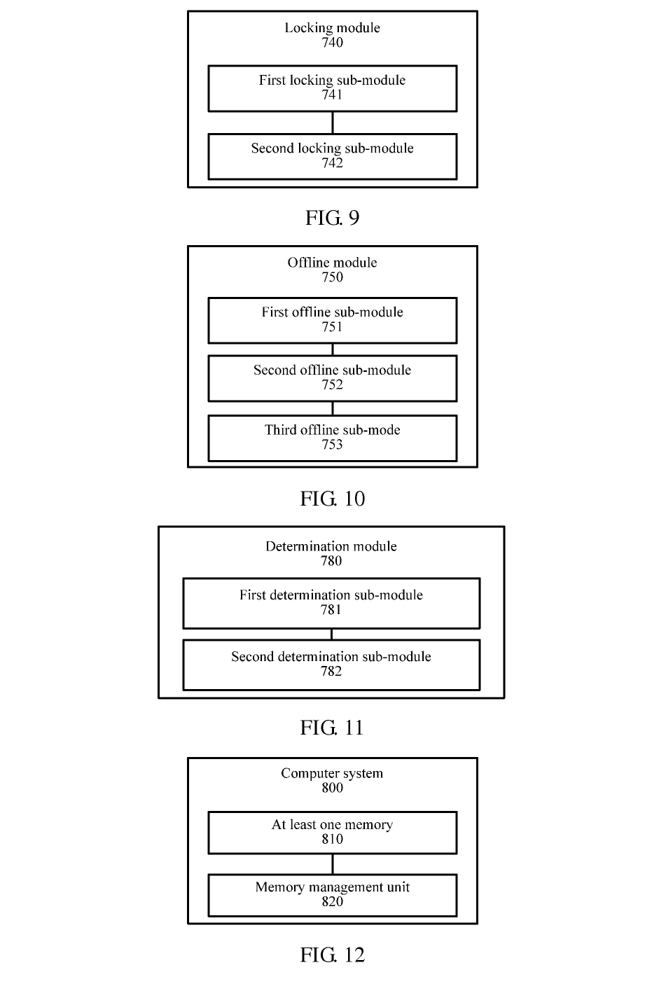

In the embodiment of the present invention, as shown in FIG. 9, the locking module 740 according to the embodiment of the present invention may include: a first locking sub-module 741, configured to lock the memory when the offline flag of the memory indicates the default mode, the notify mode or the forcible unlock mode; and a second locking sub-module 742, configured to migrate the memory when the offline flag of the memory indicates the migrate mode, if the memory is migrated successfully, lock the migrated memory and set an offline flag indicating the migrate mode for the migrated memory; and if the memory is migrated unsuccessfully, lock the memory and modify the offline flag of the memory to indicate the default mode.

Optionally, as shown in FIG. 10, the offline module 750 includes: a first offline sub-module 751, configured to wait for the memory to be unlocked when the offline flag of the memory indicates the default mode or the migrate mode, and migrate the memory after the memory is unlocked; a second offline sub-module 752, configured to trigger the user process to unlock the memory when the offline flag of the memory indicates the notify mode, migrate the memory after the memory is unlocked, and trigger the user process to lock the migrated memory after the memory is migrated; and a third offline sub-mode 753, configured to unlock the memory when the offline flag of the memory indicates the forcible unlock mode, migrate the memory after the memory is unlocked, lock the migrated memory, and set, for the migrated memory, an offline flag indicating the forcible unlock mode.

Optionally, as shown in FIG. 11, the determination module 780 includes: a first determination sub-module 781, configured to determine the offline mode of the memory to be the default mode when the computer system requires the system operating performance; and a second determination sub-module 782, configured to determine the offline mode of the memory to be the migrate mode when the computer system requires the hot-swap performance.

The memory management unit 700 according to the embodiment of the present invention may correspond to a kernel or an operating system in the method according to the embodiments of the present invention, and the foregoing and other operations and/or functions of each module in the memory management unit 700 are respectively provided for implementing the corresponding steps of the methods 100 to 500 in FIG. 1A to FIG. 5, which, for simplicity, are not described in detail here again.

In the memory management unit according to the embodiment of the present invention, through the interaction between the kernel and the user process, and setting the offline mode for the memory, the kernel can correspondingly take the memory offline according to the offline mode of the memory, so as to take the memory locked by the user process offline, thereby implementing the hot swap of the memory, improving the system performance and avoiding the waste of system resources.

FIG. 12 is a schematic block diagram of a computer system 800 according to an embodiment of the present invention. As shown in FIG. 12, the computer system includes at least one memory 810 and a memory management unit 820 according to the embodiment of the present invention, where the memory management unit 820 is configured to manage the at least one memory 810, and may include: a first receiving module, configured to receive an allocation request sent by a user process, where the allocation request is used for requesting allocation of a memory of a computer system for the user process; an allocation module, configured to allocate the memory for the user process according to the allocation request received by the first receiving module, and set an offline flag for the memory, where the offline flag is used for indicating an offline mode of the memory; a second receiving module, configured to receive a locking request sent by the user process, where the locking request is used for requesting that the memory be locked of the computer system; a locking module, configured to lock the memory according to the locking request received by the second receiving module and the offline flag of the memory; and an offline module, configured to take the memory locked by the locking module offline according to the offline flag of the memory.

In the embodiment of the present invention, optionally, the offline mode includes at least one of a default mode, a migrate mode, a notify mode and a forcible unlock mode. Optionally, the memory management unit 820 further includes: a third receiving module, configured to receive a modification request that includes mode information and is sent by the user process, where the mode information indicates an offline mode set by the user process for the memory; and a modification module, configured to modify, according to the mode information received by the third receiving module, the offline flag of the memory to indicate the offline mode set by the user process.

Optionally, the memory management unit 820 further includes: a determination module, configured to, if the offline mode of the memory is the default mode, re-determine the offline mode of the memory according to a requirement of the computer system, and modify the offline flag of the memory to indicate the re-determined offline mode.

Optionally, the memory management unit 820 further includes: a fourth receiving module, configured to receive an unlocking request sent by the user process, where the unlocking request is used for requesting that the memory be unlocked; and a remigration module, configured to, according to the unlocking request received by the fourth receiving module when the offline flag of the memory indicates the migrate mode, remigrate the memory to a node where the user process is run on.

In the embodiment of the present invention, optionally, the locking module includes: a first locking sub-module, configured to lock the memory when the offline flag of the memory indicates the default mode, the notify mode or the forcible unlock mode; and a second locking sub-module, configured to migrate the memory when the offline flag of the memory indicates the migrate mode, if the memory is migrated successfully, lock the migrated memory and set, for the migrated memory, an offline flag indicating the migrate mode; and if the memory is migrated unsuccessfully, lock the memory and modify the offline flag of the memory to indicate the default mode.

In the embodiment of the present invention, optionally, the offline module includes: a first offline sub-module, configured to wait for the memory to be unlocked when the offline flag of the memory indicates the default mode or the migrate mode, and migrate the memory after the memory is unlocked; a second offline sub-module, configured to trigger the user process to unlock the memory when the offline flag of the memory indicates the notify mode, migrate the memory after the memory is unlocked, and trigger the user process to lock the migrated memory after the memory is migrated; and a third offline sub-mode, configured to unlock the memory when the offline flag of the memory indicates the forcible unlock mode, migrate the memory after the memory is unlocked, lock the migrated memory, and set, for the migrated memory, an offline flag indicating the forcible unlock mode.

The memory management unit 820 according to the embodiment of the present invention may correspond to the memory management unit 700 in the device according to the embodiment of the present invention, and the foregoing and other operations and/or functions of each module in the memory management unit 820 are respectively provided for implementing the corresponding steps of the methods 100 to 500 in FIG. 1A to FIG. 5, which, for simplicity, are not described in detail here again.

In the computer system according to the embodiment of the present invention, through the interaction between a kernel and the user process, and setting the offline mode for the memory, the kernel can correspondingly take the memory offline according to the offline mode of the memory, so as to take the memory locked by the user process offline, thereby implementing the hot swap of the memory, improving the system performance and avoiding the waste of system resources.

It should be noted that, the locked memory in the embodiments of the present invention is not limited to a locked memory applied for by the user process, and a locked memory for other purposes may also be taken offline by using the solution according to the embodiments of the present invention. In addition, the migration policy in the offline policy for the locked memory is not limited to the solution which is formulated by the user process and executed by the kernel, and the migration policy may be that, the user process designates the memory to apply for moving to a special memory area, thereby implementing the requirement of taking the memory offline without migration.

Persons skilled in the art may realize that, units and algorithm steps of examples described in combination with the embodiments disclosed here can be implemented by electronic hardware, computer software, or the combination of the two. In order to clearly describe the interchangeability between the hardware and the software, compositions and steps of each example have been generally described according to functions in the foregoing descriptions. Whether the functions are executed by hardware or software depends on particular applications and design constraint conditions of the technical solutions. Persons skilled in the art may use different methods to implement the described functions for each particular application, but it should not be considered that the implementation goes beyond the scope of the present invention.

It can be clearly understood by persons skilled in the art that, for the purpose of convenient and brief description, for a detailed working process of the foregoing system, device and unit, reference may be made to the corresponding process in the method embodiments, and the details are not to be described here again.

In several embodiments provided in the present application, it should be understood that the disclosed system, device, and method may be implemented in other ways. For example, the described device embodiments are merely exemplary. For example, the unit division is merely logical functional division and may be other division in actual implementation. For example, multiple units or components may be combined or integrated into another system, or some features may be ignored or not performed. Furthermore, the shown or discussed coupling or direct coupling or communication connection may be accomplished through indirect coupling or communication connection between some interfaces, devices or units, or may be electrical, mechanical, or in other forms.

Units described as separate components may be or may not be physically separated. Components shown as units may be or may not be physical units, that is, may be integrated or may be distributed to a plurality of network units. Some or all of the units may be selected to achieve the objective of the solution of the embodiment according to actual demands.

In addition, the functional units in the embodiments of the present invention may either be integrated in a processing module, or each be a separate physical unit; alternatively, two or more of the units are integrated in one unit. The integrated units may be implemented through hardware or software functional units.

If implemented in the form of software functional units and sold or used as an independent product, the integrated units may also be stored in a computer readable storage medium. Based on such understanding, the technical solution of the present invention or the part that makes contributions to the prior art, or all or a part of the technical solution may be substantially embodied in the form of a software product. The computer software product is stored in a storage medium, and contains several instructions to instruct computer equipment (such as, a personal computer, a server, or network equipment) to perform all or a part of steps of the method described in the embodiments of the present invention. The storage medium includes various media capable of storing program codes, such as, a USB flash drive, a mobile hard disk, a Read-Only Memory (ROM), a Random Access Memory (RAM), a magnetic disk or an optical disk.

The foregoing descriptions are merely specific embodiments of the present invention, but the protection scope of the present invention is not limited hereto. Any equivalent modification or replacement easily thought of by persons skilled in the art within the technical scope of the present invention should fall within the protection scope of the present invention. Therefore, the protection scope of the present invention is subject to the appended claims.

What is claimed is:

1. A method for managing a memory of a computer system, comprising:
receiving an allocation request sent by a user process, wherein the allocation request is used for requesting allocation of the memory of the computer system for the user process;
allocating the memory for the user process according to the allocation request;
setting an offline flag for the memory, wherein the offline flag indicates an offline mode for the memory;
receiving a locking request sent by the user process, wherein the locking request is used for requesting that the memory be locked;
locking the memory according to the locking request and the offline flag of the memory; and
taking the memory offline according to the offline flag of the memory.

2. The method according to claim 1, further comprising:
receiving a modification request that comprises mode information and that is sent by the user process, wherein the mode information indicates an user process-set offline mode for the memory; and
modifying, according to the mode information, the offline flag of the memory to indicate the user process-set offline mode.

3. The method according to claim 1, wherein the offline mode comprises at least one of a default mode, a migrate mode, a notify mode, and a forcible unlock mode.

4. The method according to claim 3, further comprising:
re-determining the offline mode for the memory according to a requirement of the computer system when the offline mode for the memory is the default mode; and
modifying the offline flag for the memory to indicate the offline mode that is re-determined.

5. The method according to claim 4, wherein re-determining the offline mode for the memory according to the requirement of the computer system comprises:
determining the offline mode for the memory to be the default mode when the computer system requires system operating performance; or
determining the offline mode for the memory to be the migrate mode when the computer system requires hot-swap performance.

6. The method according to claim 3, wherein locking the memory according to the locking request and the offline flag of the memory comprises:
locking the memory when the offline flag of the memory indicates the default mode, the notify mode, or the forcible unlock mode;
migrating the memory when the offline flag of the memory indicates the migrate mode;
locking a migrated memory when the offline flag of the memory indicates the migrate mode and when the memory is migrated successfully;
setting, for the migrated memory, an offline flag indicating the migrate mode when the offline flag of the memory indicates the migrate mode and when the memory is migrated successfully;
locking the memory when the offline flag of the memory indicates the migrate mode and when the memory is migrated unsuccessfully; and
modifying the offline flag of the memory to indicate the default mode when the offline flag of the memory indicates the migrate mode and when the memory is migrated unsuccessfully.

7. The method according to claim 3, wherein taking the memory offline according to the offline flag of the memory comprises:
waiting for the memory to be unlocked when the offline flag of the memory indicates the default mode or the migrate mode;
migrating the memory after the memory is unlocked when the offline flag of the memory indicates the default mode or the migrate mode;
triggering the user process to unlock the memory when the offline flag of the memory indicates the notify mode;
migrating the memory after the memory is unlocked when the offline flag of the memory indicates the notify mode;
triggering the user process to lock the migrated memory after the memory is migrated when the offline flag of the memory indicates the notify mode;
unlocking the memory when the offline flag of the memory indicates the forcible unlock mode;
migrating the memory after the memory is unlocked when the offline flag of the memory indicates the forcible unlock mode;
locking the migrated memory when the offline flag of the memory indicates the forcible unlock mode; and
setting, for the migrated memory, an offline flag indicating the forcible unlock mode when the offline flag of the memory indicates the forcible unlock mode.

8. The method according to claim 3, further comprising:
receiving an unlocking request sent by the user process, wherein the unlocking request is used for requesting that the memory be unlocked; and
remigrating the memory to a node where the user process is run according to the unlocking request when the offline flag of the memory indicates the migrate mode.

9. A memory management unit, comprising:
a first receiving module configured to receive an allocation request sent by a user process, wherein the allocation request is used for requesting allocation of a memory of a computer system for the user process;
an allocation module configured to allocate the memory for the user process according to the allocation request received by the first receiving module, and set an offline flag for the memory, wherein the offline flag indicates an offline mode for the memory;
a second receiving module configured to receive a locking request sent by the user process, wherein the locking request is used for requesting that the memory of the computer system be locked;
a locking module configured to lock the memory according to the locking request received by the second receiving module and the offline flag of the memory; and
an offline module configured to take the memory locked by the locking module offline according to the offline flag of the memory.

10. The memory management unit according to claim 9, further comprising:
a third receiving module configured to receive a modification request that comprises mode information and that is sent by the user process, wherein the mode information indicates an user process-set offline mode for the memory; and
a modification module configured to modify, according to the mode information received by the third receiving module, the offline flag of the memory to indicate the user process-set offline mode.

11. The memory management unit according to claim 9, wherein the offline mode comprises at least one of a default mode, a migrate mode, a notify mode, and a forcible unlock mode.

12. The memory management unit according to claim 11, further comprising a determination module configured to re-determine the offline mode for the memory according to a requirement of the computer system and modify the offline flag of the memory to indicate the offline mode that is re-determined when the offline mode for the memory is the default mode.

13. The memory management unit according to claim 12, wherein the determination module comprises:
a first determination sub-module configured to determine that the offline mode for the memory is the default mode when the computer system requires system operating performance; or
a second determination sub-module configured to determine that the offline mode for the memory is the migrate mode when the computer system requires hot-swap performance.

14. The memory management unit according to claim 11, wherein the locking module comprises:
a first locking sub-module configured to lock the memory when the offline flag of the memory indicates the default mode, the notify mode, or the forcible unlock mode; and
a second locking sub-module configured to:
migrate the memory when the offline flag of the memory indicates the migrate mode;
lock a migrated memory when the memory is migrated successfully;
set, for the migrated memory, an offline flag indicating the migrate mode when the memory is migrated successfully;
lock the memory when the memory is migrated unsuccessfully; and
modify the offline flag of the memory to indicate the default mode when the memory is migrated unsuccessfully.

15. The memory management unit according to claim 11, wherein the offline module comprises:
a first offline sub-module configured to wait for the memory to be unlocked when the offline flag of the memory indicates the default mode or the migrate mode, and migrate the memory after the memory is unlocked;
a second offline sub-module configured to trigger the user process to unlock the memory when the offline flag of the memory indicates the notify mode, migrate the memory after the memory is unlocked, and trigger the user process to lock the migrated memory after the memory is migrated; and
a third offline sub-mode configured to unlock the memory when the offline flag of the memory indicates the forcible unlock mode, migrate the memory after the memory is unlocked, lock the migrated memory, and set, for the migrated memory, an offline flag indicating the forcible unlock mode.

16. The memory management unit according to claim 11, further comprising:
a fourth receiving module configured to receive an unlocking request sent by the user process, wherein the unlocking request is used for requesting that the memory be unlocked; and
a remigration module configured to remigrate the memory to a node where the user process is run according to the unlocking request received by the fourth receiving module when the offline flag of the memory indicates the migrate mode.

17. A computer system comprising:
at least one memory; and
a processor connected to the memory and configured to:
receive an allocation request sent by a user process, wherein the allocation request is used for requesting allocation of the memory of the computer system for the user process;
allocate the memory for the user process according to the allocation request;
set an offline flag for the memory, wherein the offline flag indicates an offline mode for the memory;
receive a locking request sent by the user process, wherein the locking request is used for requesting that the memory be locked;
lock the memory according to the locking request and the offline flag of the memory; and
take the memory offline according to the offline flag of the memory.

18. The system according to claim 17, wherein the processor is further configured to:
receive a modification request that comprises mode information and that is sent by the user process, wherein the mode information indicates an user process-set offline mode for the memory; and
modify, according to the mode information, the offline flag of the memory to indicate the user process-set offline mode.

19. The system according to claim 17, wherein the offline mode comprises at least one of a default mode, a migrate mode, a notify mode, and a forcible unlock mode.

20. The system according to claim 19, wherein the processor is further configured to:
re-determine the offline mode for the memory according to a requirement of the computer system when the offline mode for the memory is the default mode; and
modify the offline flag of the memory to indicate the offline mode that is re-determined.

21. The system according to claim 20, wherein in re-determining the offline mode for the memory according to the requirement of the computer system, the processor is further configured to:
determine the offline mode for the memory to be the default mode when the computer system requires system operating performance; or
determine the offline mode for the memory to be the migrate mode when the computer system requires hot-swap performance.

22. The system according to claim 19, wherein in locking the memory according to the locking request and the offline flag of the memory, the processor is further configured to:
lock the memory when the offline flag of the memory indicates the default mode, the notify mode, or the forcible unlock mode;
migrate the memory when the offline flag of the memory indicates the migrate mode;
lock a migrated memory when the offline flag of the memory indicates the migrate mode and when the memory is migrated successfully;
set, for the migrated memory, an offline flag indicating the migrate mode when the offline flag of the memory indicates the migrate mode and when the memory is migrated successfully;
lock the memory when the offline flag of the memory indicates the migrate mode and when the memory is migrated unsuccessfully; and
modify the offline flag of the memory to indicate the default mode when the offline flag of the memory indicates the migrate mode and when the memory is migrated unsuccessfully.

23. The system according to claim 19, wherein in taking the memory offline according to the offline flag of the memory, the processor is further configured to:
wait for the memory to be unlocked when the offline flag of the memory indicates the default mode or the migrate mode;
migrate the memory after the memory is unlocked when the offline flag of the memory indicates the default mode or the migrate mode;
trigger the user process to unlock the memory when the offline flag of the memory indicates the notify mode;
migrate the memory after the memory is unlocked when the offline flag of the memory indicates the notify mode;
trigger the user process to lock the migrated memory after the memory is migrated when the offline flag of the memory indicates the notify mode;
unlock the memory when the offline flag of the memory indicates the forcible unlock mode;
migrate the memory after the memory is unlocked when the offline flag of the memory indicates the forcible unlock mode;
lock the migrated memory when the offline flag of the memory indicates the forcible unlock mode; and
set, for the migrated memory, an offline flag indicating the forcible unlock mode when the offline flag of the memory indicates the forcible unlock mode.

24. The system according to claim 19, wherein the processor is further configured to:
receive an unlocking request sent by the user process, wherein the unlocking request is used for requesting that the memory be unlocked; and
remigrate the memory to a node where the user process is run according to the unlocking request when the offline flag of the memory indicates the migrate mode.

25. A non-transitory computer readable medium having computer executable instructions for performing a method, the method comprising:
receiving an allocation request sent by a user process, wherein the allocation request is used for requesting allocation of a memory of the computer system for the user process;
allocating the memory for the user process according to the allocation request;
setting an offline flag for the memory, wherein the offline flag indicates an offline mode for the memory;
receiving a locking request sent by the user process, wherein the locking request is used for requesting that the memory be locked;
locking the memory according to the locking request and the offline flag of the memory; and
taking the memory offline according to the offline flag of the memory.
